(19) United States
(12) Patent Application Publication
(10) Pub. No.: US 2015/0367237 A1
(43) Pub. Date: Dec. 24, 2015

(54) METHOD, APPARATUS AND SYSTEM FOR EXPRESSING AND EXCHANGING OPINIONS ON VIRTUAL OBJECTS

(71) Applicant: ICELERO INC, San Jose, CA (US)

(72) Inventors: Amit Ramchandran, San Jose, CA (US); Amir Masoud Zarkesh, Saratoga, CA (US)

(21) Appl. No.: 14/404,082

(22) PCT Filed: Mar. 13, 2013
(86) PCT No.: PCT/US13/30735

§ 371 Date: Nov. 26, 2014

Related U.S. Application Data
(60) Provisional application No. 61/652,333, filed on May 29, 2012.

(51) Int. Cl. A63F 13/67; A63F 13/79; A63F 13/825

(52) U.S. Cl. CPC A63F 13/67; A63F 13/825; A63F 13/79

(57) ABSTRACT

A system, method and computer program product for multi -player video gaming, including a virtual representation of a first user; a virtual object provided to the first user by a second user or a virtual representation of the second user; and the virtual object provided by the second user configured to influence a level of emotion and feeling, including health and happiness of the virtual representation of the first user.

### CROSS REFERENCE TO RELATED DOCUMENTS

The present invention claims benefit of priority to U.S. Provisional Patent Application Ser. No. 61/652,333 of Amit RAMCHANDRAN et al., entitled “A METHOD, APPARATUS AND SYSTEM FOR EXPRESSING AND EXCHANGING OPINION ON ANY VIRTUAL OBJECT,” filed on May 29, 2012, and is related to PCT Patent Application Serial No. PCT/US12/70688 of Amir Masoud ZARKESH et al., entitled “METHOD AND SYSTEM FOR CREATING A VIRTUAL SOCIAL AND GAMING EXPERIENCE,” filed on Dec. 19, 2012, the entire disclosures of all of which are hereby incorporated by reference herein.

### BACKGROUND OF THE INVENTION

1. Field of the Invention

The present invention generally relates to systems and methods for video gaming, and more particularly to systems and methods for exchanging opinions on virtual objects, and the like.

2. Discussion of the Background

In recent years, systems and methods for exchanging opinions on virtual objects on the Internet, such as Facebook's “Like” button, Google's “+1” button, and the like, methods of expressing opinions that can then be shared with friends through news feeds, and the like, have been developed. However, such systems and methods have been hindered by various problems, for example, including problems related to levels of user and virtual object interaction, and the like.

### SUMMARY OF THE INVENTION

Therefore, there is a need for methods and systems that address the above and other problems with systems and methods for exchanging opinions on virtual objects, and the like. Accordingly, the above and other needs are addressed by the illustrative embodiments of the present invention, which provide a novel method and system to make the expression and exchange of user opinions, and the like, engaging, interactive and profitable for users through a social game, and the like. Such a game can involve an interaction between users, their friends, people they may know directly or indirectly with a wide collection of virtual objects that can represent all suitable inanimate objects and living beings in the universe. The present invention allows for such interaction to take place seamlessly between users in different geographic locations over all kinds of network conditions, including during a complete loss of network connection. The present invention can generate proxy-players that are representative of a real user's likes and dislikes through social collaborative filtering techniques and allow users to throw virtual objects at proxy players in a social game. The virtual objects thrown at proxy-players can influence the level of emotion and feeling, for example, health and happiness, and the like, of the proxy-player. Every real user can have his/her own proxy-player that can in-turn collect virtual objects thrown at it by other real users. The real user can have the opportunity to view objects that are being thrown at his/her proxy-player and also make explicit adjustments to their proxy player, which may in turn result in a change in the level of emotion or feeling.

Accordingly, in an illustrative aspect, there is provided a system, method and computer program product for multi-player video gaming, including a virtual representation of a first user; a virtual object provided to the first user by a second user or a virtual representation of the second user; and the virtual object provided by the second user configured to influence a level of emotion and feeling, including health and happiness of the virtual representation of the first user.

The virtual representation of the first user is representative of likes and dislikes of the first user obtained through social collaborative filtering techniques.

The virtual representation of the first user is configured to collect virtual objects received from other users or virtual representations of other users.

The system, method and computer program product are configure to allow the first user to view the virtual object being received by the virtual representation of the first user and make adjustments to the virtual representation of the first user so as to result in a change in a level of emotion or feeling of the virtual representation of the first user.

Still other aspects, features, and advantages of the present invention are readily apparent from the following detailed description, simply by illustrating a number of illustrative embodiments and implementations, including the best mode contemplated for carrying out the present invention. The present invention also is capable of other and different embodiments, and its several details can be modified in various respects, all without departing from the spirit and scope of the present invention. Accordingly, the drawings and descriptions are to be regarded as illustrative in nature, and not as restrictive.

### BRIEF DESCRIPTION OF THE DRAWINGS

The embodiments of the present invention are illustrated by way of example, and not by way of limitation, in the figures of the accompanying drawings, in which like reference numerals refer to similar elements, and in which:

FIG. 1 is an illustrative diagram for systems and methods for exchanging opinions on virtual objects, and the like.

### DETAILED DESCRIPTION OF THE PREFERRED EMBODIMENTS

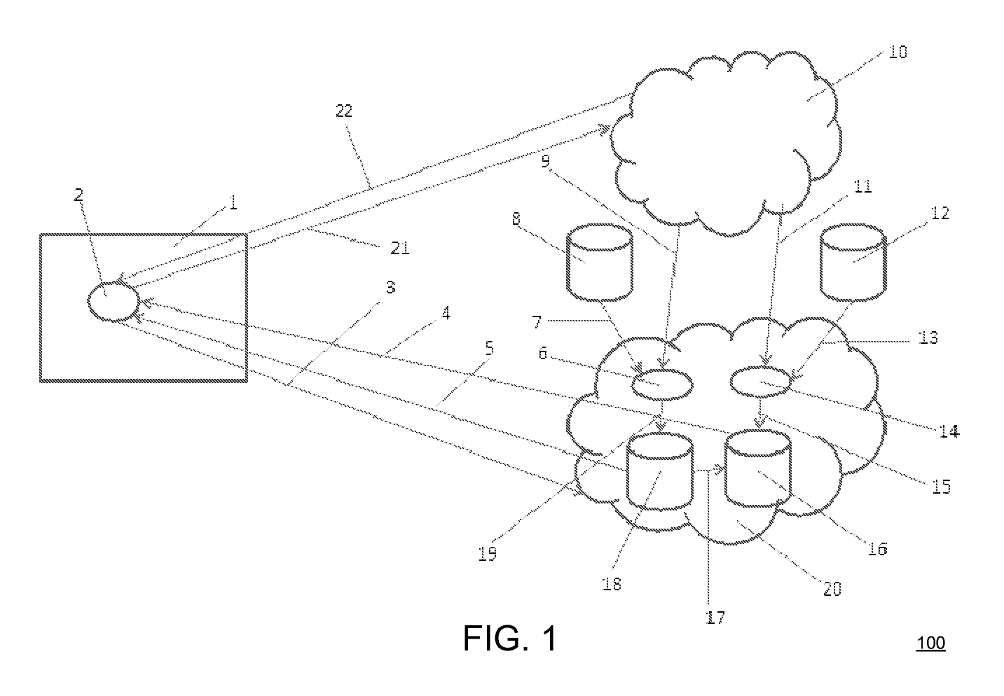

Referring now to the drawings, in FIG. 1 there is shown an illustrative diagram 100 for systems and methods for exchanging opinions on virtual objects, and the like. In FIG. 1, the system 100 can include cloud servers 20 including a database of proxy-players 18 and a database of virtual objects 16. The database of proxy players 18 can be derived, for example, automatically by mining, and the like, social and syndicate data from the Internet 10 via link 9 using a suitable method 6. The method 6 also can allow for third party corporations 8, and the like, to add proxy-players to the database 18 via link 7 and a suitable method 6. The database of virtual objects 16 can be derived, for example, automatically over link 15 by mining a variety of data sets from the Internet 10 via link 11 using a suitable method 14. The databases 18 and 16 can be configured to receive items from an application 2 running in a device 1, for example, using a suitable feedback method 3, and the like. In a similar manner, the method 14 also can allow for other type of third parties 12, and the like, to add virtual objects to the database 16 via link 13 and a suitable method 14.

The application 2 can be a game in which users choose from plurality of virtual objects in the database 16 to throw (e.g., using any suitable method, such as finger swipes, sling shots, etc.) at one or more proxy players from the database 18. The effect that an object has on a proxy player is recorded in terms of metrics representing health, happiness, and the like. The objective of the game is to keep a proxy player happy and or healthy for as long as possible so that he/she continues to remain on the user's screen.

The relationship between the proxy players and the virtual objects that define the positive or negative impact on a proxy player's health and happiness can determined by a suitable method 17. For example, if a proxy player's vital statistics, health and/or happiness drop below a certain threshold then the proxy player disappears from the screen. The real users are also able to see the objects that are being thrown at their representative proxy players. A player can adjust such vital statistics to improve their proxy-player for future game plays. In order to make this game work seamlessly and efficiently over mobile networks, a set of proxy players and virtual objects can be pre-positioned in the client device 1 using suitable methods 5 and 4, respectively, so that the user can engage the proxy player of any of his/her friends, even while they are not available to play.

The pre-positioned virtual objects in the application 2 can be updated from time to time via a pull mechanism, and the like, from the application 2 by as suitable method 3 or via push mechanism, and the like, into application 2 by a suitable method 4. Similarly, the pre-positioned proxy-players in the application 2 can be updated from time to time by via a pull mechanism, and the like, from the application 2 by as suitable method 3 or via push mechanism, and the like, into application 2 by a suitable method 5.

A limited set of virtual objects can be made available in each turn of the game as options to be thrown. The choice of the limited set of virtual objects, as well as the health and happiness metric numbers, and the like, can be determined, for example, based on any suitable algorithm running in the application 2 and/or through a suitable method 5, for example, including using mechanisms for expressing social networking opinions, such as Facebook's “Like” button, Google's “+1” button, and the like, by the players and/or their friends.

The database 16 can include objects that are products with specific brands and/or the brands themselves. Advantageously, both the player that throws the branded objects and/or brands, and the receiving player are subject to exposure to the corresponding brands. This provides a new method, apparatus, and system of recommendation-based advertisement for branded products or brands directly and explicitly embedded in a social game. As the result the brand owners can be charged either for inclusion of their brand in the database 16 and/or based on the number of times their branded objects and/or brands are exposed to a player and/or are thrown to a proxy-player.

The brands and/or the branded objects can be configured to provide further information and/or offers to purchase products and/or services related to the brands and/or the branded objects. The transaction to purchase a branded object can be initiated directly from the game. In addition, the application 2 can be configured to request information 21 from other sites, and the like, over the Internet 10, and receive suitable response 22 over the Internet 10. In this way, the application 2 can add new objects to the database 16 and/or new proxy-players to the database 18, for example, including Internet content, offers, and the like, gathered from the Internet 10, and friends, and the like, of the owner of the device 1 gathered through various social networks, and the like, on the Internet 10.

The above-described devices and subsystems of the illustrative embodiments can include, for example, any suitable servers, workstations, PCs, laptop computers, PDAs, Internet appliances, handheld devices, cellular telephones, wireless devices, other electronic devices, and the like, capable of performing the processes of the illustrative embodiments. The devices and subsystems of the illustrative embodiments can communicate with each other using any suitable protocol and can be implemented using one or more programmed computer systems or devices.

One or more interface mechanisms can be used with the illustrative embodiments, including, for example, Internet access, telecommunications in any suitable form (e.g., voice, modem, and the like), wireless communications media, and the like. For example, employed communications networks or links can include one or more wireless communications networks, cellular communications networks, cable communications networks, satellite communications networks, G3 communications networks, Public Switched Telephone Network (PSTNs), Packet Data Networks (PDNs), the Internet, intranets, WiMax Networks, a combination thereof, and the like.

It is to be understood that the devices and subsystems of the illustrative embodiments are for illustrative purposes, as many variations of the specific hardware and/or software used to implement the illustrative embodiments are possible, as will be appreciated by those skilled in the relevant art(s). For example, the functionality of one or more of the devices and subsystems of the illustrative embodiments can be implemented via one or more programmed computer systems or devices.

To implement such variations as well as other variations, a single computer system can be programmed to perform the special purpose functions of one or more of the devices and subsystems of the illustrative embodiments. On the other hand, two or more programmed computer systems or devices can be substituted for any one of the devices and subsystems of the illustrative embodiments. Accordingly, principles and advantages of distributed processing, such as redundancy, replication, and the like, also can be implemented, as desired, to increase the robustness and performance the devices and subsystems of the illustrative embodiments.

The devices and subsystems of the illustrative embodiments can store information relating to various processes described herein. This information can be stored in one or more memories, such as a hard disk, optical disk, magneto-optical disk, RAM, and the like, of the devices and subsystems of the illustrative embodiments. One or more databases of the devices and subsystems of the illustrative embodiments can store the information used to implement the illustrative embodiments of the present invention. The databases can be organized using data structures (e.g., records, tables, arrays, fields, graphs, trees, lists, and the like) included in one or more memories or storage devices listed herein. The processes described with respect to the illustrative embodiments can include appropriate data structures for storing data collected and/or generated by the processes of the devices and subsystems of the illustrative embodiments in one or more databases thereof.

All or a portion of the devices and subsystems of the illustrative embodiments can be conveniently implemented using one or more general purpose computer systems, microprocessors, digital signal processors, micro-controllers, application processors, domain specific processors, application specific signal processors, and the like, programmed according to the teachings of the illustrative embodiments of the present invention, as will be appreciated by those skilled in the computer and software arts. Appropriate software can be readily prepared by programmers of ordinary skill based on the teachings of the illustrative embodiments, as will be appreciated by those skilled in the software art. In addition, the devices and subsystems of the illustrative embodiments can be implemented by the preparation of application-specific integrated circuits or by interconnecting an appropriate network of conventional component circuits, as will be appreciated by those skilled in the electrical art(s). Thus, the illustrative embodiments are not limited to any specific combination of hardware circuitry and/or software.

Stored on any one or on a combination of computer readable media, the illustrative embodiments of the present invention can include software for controlling the devices and subsystems of the illustrative embodiments, for driving the devices and subsystems of the illustrative embodiments, for enabling the devices and subsystems of the illustrative embodiments to interact with a human user, and the like. Such software can include, but is not limited to, device drivers, firmware, operating systems, development tools, applications software, and the like. Such computer readable media further can include the computer program product of an embodiment of the present invention for performing all or a portion (if processing is distributed) of the processing performed in implementing the illustrative embodiments. Computer code devices of the illustrative embodiments of the present invention can include any suitable interpretable or executable code mechanism, including but not limited to scripts, interpretable programs, dynamic link libraries (DLLs), Java classes and applets, complete executable programs, Common Object Request Broker Architecture (CORBA) objects, and the like. Moreover, parts of the processing of the illustrative embodiments of the present invention can be distributed for better performance, reliability, cost, and the like.

As stated above, the devices and subsystems of the illustrative embodiments can include computer readable medium or memories for holding instructions programmed according to the teachings of the present invention and for holding data structures, tables, records, and/or other data described herein. Computer readable medium can include any suitable medium that participates in providing instructions to a processor for execution. Such a medium can take many forms, including but not limited to, non-volatile media, volatile media, transmission media, and the like. Non-volatile media can include, for example, optical or magnetic disks, magneto-optical disks, and the like. Volatile media can include dynamic memories, and the like. Transmission media can include coaxial cables, copper wire, fiber optics, and the like. Transmission media also can take the form of acoustic, optical, electromagnetic waves, and the like, such as those generated during radio frequency (RF) communications, infrared (IR) data communications, and the like. Common forms of computer-readable media can include, for example, a floppy disk, a flexible disk, hard disk, magnetic tape, any other suitable magnetic medium, a CD-ROM, CDRW, DVD, any other suitable optical medium, punch cards, paper tape, optical mark sheets, any other suitable physical medium with patterns of holes or other optically recognizable indicia, a RAM, a PROM, an EPROM, a FLASH-EPROM, any other suitable memory chip or cartridge, a carrier wave, or any other suitable medium from which a computer can read.

While the present invention have been described in connection with a number of illustrative embodiments and implementations, the present invention is not so limited, but rather covers various modifications and equivalent arrangements, which fall within the purview of the appended claims.

What is claimed is:

1. A system for multi-player video gaming, the system comprising:
a virtual representation of a first user;
a virtual object provided to the first user by a second user or a virtual representation of the second user; and
the virtual object provided by the second user configured to influence a level of emotion and feeling, including health and happiness of the virtual representation of the first user.

2. The system of claim 1, wherein the virtual representation of the first user is representative of likes and dislikes of the first user obtained through social collaborative filtering techniques.

3. The system of claim 1, wherein the virtual representation of the first user is configured to collect virtual objects received from other users or virtual representations of other users.

4. The system of claim 1, wherein the system is configure to allow the first user to view the virtual object being received by the virtual representation of the first user and make adjustments to the virtual representation of the first user so as to result in a change in a level of emotion or feeling of the virtual representation of the first user.

5. A method for multi-player video gaming, the method comprising:
generating a virtual representation of a first user;
generating a virtual object provided to the first user by a second user or a virtual representation of the second user; and
influencing with the virtual object provided by the second user a level of emotion and feeling, including health and happiness of the virtual representation of the first user.

6. The method of claim 5, wherein the virtual representation of the first user is representative of likes and dislikes of the first user obtained through social collaborative filtering techniques.

7. The method of claim 5, further comprising collecting by the virtual representation of the first user virtual objects received from other users or virtual representations of other users.

8. The method of claim 5, further comprising allowing the first user to view the virtual object being received by the virtual representation of the first user and make adjustments to the virtual representation of the first user so as to result in a change in a level of emotion or feeling of the virtual representation of the first user.

9. A computer program product for multi-player video gaming, and including one or more computer readable instructions embedded on a non-transitory, tangible computer readable medium and configured to cause one or more computer processors to perform the steps of:
generating a virtual representation of a first user;
generating a virtual object provided to the first user by a second user or a virtual representation of the second user; and
influencing with the virtual object provided by the second user a level of emotion and feeling, including health and happiness of the virtual representation of the first user.

10. The computer program product of claim 9, wherein the virtual representation of the first user is representative of likes and dislikes of the first user obtained through social collaborative filtering techniques.

11. The computer program product of claim 9, further comprising collecting by the virtual representation of the first user virtual objects received from other users or virtual representations of other users.

12. The computer program product of claim 9, further comprising allowing the first user to view the virtual object being received by the virtual representation of the first user and make adjustments to the virtual representation of the first user so as to result in a change in a level of emotion or feeling of the virtual representation of the first user.
